(19) United States
(12) Patent Application Publication
(10) Pub. No.: US 2006/0242784 A1
(43) Pub. Date: Nov. 2, 2006

(54) Drying gantry for a vehicle wash plant

(76) Inventor: Wolfgang Decker, Zusmarshausen (DE)

Correspondence Address: BACON & THOMAS, PLLC, 625 SLATERS LANE, FOURTH FLOOR, ALEXANDRIA, VA, 22314, US

(21) Appl. No.: 11/411,856

(22) Filed: Apr. 27, 2006

(30) Foreign Application Priority Data
Apr. 28, 2005 (DE) 10 2005 019 618.7

(51) Int. Cl. B60S 1/66

(52) U.S. Cl. 15/316.1

(57) ABSTRACT

A drying gantry for vehicle wash plants is proposed having at least one height-adjustable cross-beam to which a blower arrangement is attached for drying the surfaces of a vehicle over which the cross-beam moves. The blower arrangement is provided with a nozzle mouth arrangement forming a lower contour of the cross-beam, with the height position of the cross-beam being controllable depending on a desired distance between the lower contour of the cross-beam and the vehicle over which the cross-beam moves. The drying gantry is characterised in that the lower contour of the cross-beam in a region approximately corresponding to the middle of the vehicle width and on both lateral ends of the vehicle recedes towards the top, thus forming clear spaces.

### FIELD OF THE INVENTION

This invention relates to a drying gantry for a vehicle wash plant according to the generic part of claim 1.

### BACKGROUND OF THE INVENTION

Vehicle wash plants of the known type are usually designed as gantry wash plants having either a movable work gantry for use with stationary vehicles, or as wash plants having fixed work stations through which vehicles are advanced. For drying the primarily horizontal surfaces (bonnet, roof, boot), two different methods are known:

In the case of the first method, blowers, which are provided with a fixed air outlet nozzle, are mounted on a fixed machine cross-beam whose height is adjusted in such a manner that all vehicles to be dried can move underneath it. Although such a plant is in principle suitable for all vehicles whose height corresponds to the drive-through height of the drying station or the drying gantry, respectively, the disadvantage of this method lies in the fact that the drying effect on vehicles having a smaller height will be greatly decreased. Using stronger blowers, on the other hand, is not considered a feasible alternative for economic reasons, that is to say high operating expenses, for technical reasons, that is to say scarcity of space, or is otherwise doomed to fail because the emission values prescribed by the authorities cannot be observed when such highly overdimensioned plants are operated.

Furthermore, so-called contour-following scan nozzles have become well established today. In such an arrangement, a blower casing, having a drying nozzle which extends over the entire drying width, is mounted on a vertically adjustable machine cross-beam. The height of the machine cross-beam is controlled via light barriers or other suitable control devices which scan the vehicle as it is moving into the drying station or as the drying gantry is moving over it. Such a drying system is depicted in FIG. 5. FIG. 5 shows a gantry wash plant with a cleaned car inside which is to be dried. On the gantry, provision is made for a drying system which comprises a lateral blower device 1 having two lateral blowers and two lateral nozzles, as well as a roof nozzle 2 designed as a contour-following scan nozzle having an integrated blower. Such roof nozzle 2 is mounted on a cross-beam and can thus be guided along lateral guide rails in an upward and downward direction. The upward and downward movements are effected steplessly, for example, via a flat belt and a suitable hoist drive. The vehicle is contour-scanned by an infrared light barrier control. For this purpose, several light barriers 3 are arranged on the right-hand side and the left-hand side of the contour-following scan nozzle. As is evident, the nozzle mouth of the contour-following scan nozzle extends over the entire width of the cross-beam, with the air supply provided by two blowers mounted on the right and left-hand side of the roof nozzle blower casing. This results in a relatively small blow range of the roof nozzle 2, so that a relatively small distance from the vehicle has to be maintained.

Particularly in the case of vehicles fitted with roof and/or side-mounted equipment, such as blue lights, taxi roof lights, mid-roof aerials mounted on the vehicle roof as well as rigid side aerials as they are customary in the United States and on US-influenced markets, there exists the danger of such equipment being damaged or broken. Even in the case of roof racks or spare tyres mounted on the rear of a vehicle, there exists the danger that the light barrier does not recognise the obstacle as such, but instead follows the outside contour of the car without allowing for the equipment mounted thereon or attached thereto, which may cause damage to the car and may further lead to warranty claims against the owner or operator of the wash plant.

### SUMMARY OF THE INVENTION

It is therefore the object of the invention to provide a drying gantry for vehicle wash plants which ensures the desired drying effect expected by the vehicle owner, while energy consumption is kept low and without involving any liability risks to the owner or operator of the wash plant arising from any damage that may be caused to the vehicles to be dried.

The object of the invention is achieved by the characteristics of claim 1.

According to the invention, provision is made for a blower arrangement having a nozzle mouth arrangement mounted on the cross-beam which does not define the lower contour of the cross-beam by a horizontal line, but leaves clear spaces corresponding to a region approximately in the middle of the vehicle width and on both side flanks and side ends of the vehicle, respectively, so that unrecognised roof and/or side-mounted equipment is not contacted even when the sensors provided for the scanning of the vehicle, and thus the sensor input-analysing height control of the cross-beam and the blower arrangement connected therewith fail to recognise such obstacles. The cross-beam can be moved in height, for example, along lateral guide rails which are attached to corresponding pillars of the wash plant, with the height position of the cross-beam depending on an input of sensors provided for scanning the vehicle (F), such as a light barrier, being set in such a manner that the distance between the lower contour of the cross-beam and the vehicle surfaces over which the cross-beam moves remains constant during the drying process. The gradient of the flanks of the lower contour of the cross-beam, declining at the clear spaces may be of either vertical, angular or curved configuration.

Advantageous further developments are the subject of the sub-claims.

Thus, the nozzle mouth arrangement forming the lower contour of the cross-beam may comprise a left-hand nozzle mouth and a right-hand nozzle mouth which are spaced from each other by a middle clear space in the vehicle transverse direction. Since such a nozzle mouth arrangement is substantially shorter than a nozzle mouth extending over the entire width of the cross-beam, the outlet width of the nozzle mouth arrangement can be adapted accordingly. This results in a substantially increased nozzle blow range without causing a pressure drop. For this reason, the distance between the nozzle mouth and the surface to be dried can be likewise increased.

In this manner, it will be prevented that roof-mounted equipment (roof rails, ski racks, blue lights, taxi roof lights, etc) are damaged and further that the nozzle contacts any spare tyres mounted on the rear end as it is the case with off-road vehicles. The location of the middle clear space provided for moving over mid-roof aerials as viewed in the vehicle transverse direction may be set, for example, relative to the lateral wheel-guide rails provided in the wash plant, with lateral tolerances having to be taken into account to compensate for different vehicle widths and positions. The two outer clear spaces, however, are selected in such a manner that rigid vehicle aerials mounted for example on the vehicle wing lie outside the working range of the drying system. The right-hand nozzle mouth and the left-hand nozzle mouth in an advantageous manner face the vehicle in a direction transverse thereto.

The height of the drying cross-beam is controlled by well-known ways and methods, such as light barrier sensors scanning the vehicle contour and thus defining the height coordinate for the drying cross-beam. The height-adjustable cross-beam can be lifted and lowered along guide rails mounted, for example, on the right and left pillars of a gantry by means of a hoisting belt which is either reeled up directly or moved via a toothed belt with weight-compensation.

It may be advantageous to make provision for two blowers mounted on the bottom side of the cross-beam and spaced in the vehicle transverse direction in such a manner that a clear space is formed in the middle. On the one hand, this ensures that the safety function for the middle area of the vehicle is provided. On the other hand, the distance between the vehicle and the left-hand nozzle mouth and the right-hand nozzle mouth, respectively, of the two blowers and thus the deepest point of the height-adjustable cross-beam can be much larger than with the contour-following scan nozzles extending over the entire vehicle width which are customary today. The effect of the short nozzle mouth arrangement described above is further enhanced by the effect of a shorter distance travelled by the air which is accelerated in the blowers, thus largely preventing frictional losses in lines and/or tubes, since the air from the blowers is directly discharged onto the vehicle.

Due to the larger distance, the two air streams issuing from the right-hand and left-hand blower and emanating from the respective nozzle mouths reach the full width of the vehicle, even though the right and left-hand nozzle mouths themselves all in all only cover a small section of the vehicle width. Furthermore, the air stream blowing frontally onto the vehicle in a region underneath the respective nozzle mouths will be deflected along the vehicle contour, thus sweeping over the entire vehicle surface so that a satisfactory drying effect over the entire vehicle width will be obtained.

Conventional blowers are approximately designed as worm-shaped components, that is to say components with a substantially cylindrical outside contour having a nozzle stub or outlet pipe connection towards the nozzle mouth. It may be particularly advantageous to select the size of the blowers in such a manner that the outside contours of the two blowers in the region of the two side flanks of the vehicle recede towards the top, following a circular path, thus leaving lateral clear spaces. In this way, the space available between the said lateral clear spaces can be optimally used for the blowers, so that blowers with relatively large rotor diameters and thus low speeds of rotation providing a high level of efficiency can be used. It would of course also be conceivable to use smaller blowers having a correspondingly higher speed of rotation, as long as the above safety requirements defining the clear spaces are maintained. The same applies to blowers of other structural shapes, so that blowers of any conceivable types (such as axial flow or radial flow compressor models or mixed-type models) may be used.

Further advantageous embodiments of the invention relate to additional functions which may be provided by a drying gantry according to the invention. Thus, for example, the right and left-hand nozzle mouths, or the blowers, in case these are attached to the cross-beam, can be swivel-mounted on the cross-beam, so that a good drying effect is ensured not only on the horizontal surfaces of the vehicle to be dried but also on the slanting surfaces, as for example on the rear end, the front or the flanks of the vehicle. In such an arrangement, provision may be made for the nozzle mouths or the blowers to be swivelled about an axis disposed in the vehicle longitudinal direction, in order to concentrate the air stream when, for example, the gantry moves forwards, onto the middle of the vehicle roof and to direct it mainly to the outside area of the roof surface as the gantry moves back. On the other hand, provision may also be made for the nozzle mouth arrangement or the blowers, respectively, to be swivelled about an axis essentially disposed in the vehicle transverse direction, in order to direct the air stream at the front and rear end sections of the vehicle. The nozzles remain within the areas defined by the light barriers or other control devices, with the swivel movements likewise being controllable by the input values provided by the control devices. Moreover, a multi-axial swivel movement of the nozzle mouth arrangement or the blowers, respectively, is likewise conceivable. Furthermore, it would also be conceivable to suspend the blowers in such a manner that they are movable on the drying cross-beam in the vehicle transverse direction. In this context, provision could be made for scanning the vehicle width by means of suitable sensors (for example a light barrier or radar) to determine the exact width of the vehicle and the exact width coordinate of the vehicle in relation to the drying gantry, and to exactly set the desirable clear spaces by correspondingly adjusting the blowers along the cross-beam.

In addition, provision may be made on the cross-beam or the blowers, respectively, for a spray tube arrangement which can be used for high-pressure pre-washing, in particular of the horizontal vehicle surfaces. If the spray tube arrangement consists of individual spray tubes with each of them being associated with a nozzle mouth, it can be ensured that the spray tubes do not protrude into the clear spaces required for side aerials and roof-mounted equipment. The spray tubes, in an advantageous manner, are arranged parallel to and near the respective nozzle mouths, since in this way the distance from the vehicle to be cleaned is kept small, the pressure of the spray agent is well utilised and thus a good cleaning effect obtained.

It goes without saying that the characteristics stated above and those to be further described in the following can be used not only in the combination described herein, but likewise in other combinations or as stand-alone features without thereby leaving the scope of this invention.

### BRIEF DESCRIPTION OF THE DRAWING

In the following, preferred embodiments will be described in greater detail with reference to schematic drawings wherein—

FIG. 1 is a schematic illustration of a gantry wash plant having a drying gantry according to a first embodiment of the invention;

FIG. 2 shows a gantry wash plant in forward motion, having a drying gantry according to a second embodiment of the invention;

FIG. 3 shows the gantry wash plant from FIG. 2 in reverse motion;

FIG. 4 shows a detailed view of a blower and its suspension to the cross-beam of a drying gantry according to a further embodiment of the invention; and

FIG. 5 shows a schematic view of a gantry wash plant having a prior art drying gantry.

### DESCRIPTION OF THE PREFERRED EMBODIMENTS

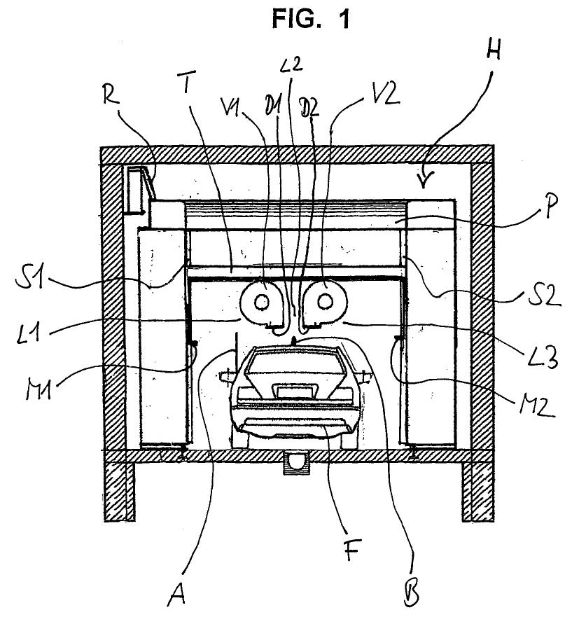

At first, reference is made to FIG. 1. This Figure shows a hall H of a gantry wash plant having a portal P which is provided with a drying gantry according to a first embodiment of the invention. On both side pillars of the gantry P there are guide rails S1, S2 arranged accommodating a cross-beam T which can be adjusted in height. The height can be adjusted by means of a belt drive indicated by R. To control the belt drive R, provision is made for light barrier sensors M1, M2 mounted on brackets which are in turn attached to the sides of the cross-beam T, such light barrier sensors M1, M2 scanning a vehicle F that has been driven into the gantry wash plant. The desirable distance between the cross-beam T and a vehicle F to be dried can be defined by the length of the said brackets. Suspended from the bottom side of the cross-beam T is a blower unit comprising two blowers V1, V2. Each of the blowers V1, V2 is provided with a nozzle mouth D1, D2 extending in the vehicle transverse direction and positioned approximately parallel to the vehicle roof, by which nozzle mouths D1, D2 the air stream is directed at the vehicle to be dried.

The vehicle F is provided with a fixed aerial A which is mounted on the vehicle wing. Furthermore, a blue light B is mounted in the middle of the vehicle roof. It is evident that a middle clear space L2 between the two blowers V1, V2 is associated with the blue light B, so that even in the event that the light barrier M1, M2 fails to detect the blue light B, there exists no danger of the blowers or the nozzle butts V1, V2, respectively, colliding with the blue light B. It is further evident that the lateral clear spaces L1, L3 provide for a safety distance from the laterally mounted equipment on the vehicle, in this case the fixed aerial A, so that in this region also there exists no danger of collision, if such laterally mounted equipment is not detected by the light barriers M1, M2. In the embodiment shown, the two blowers V1, V2 are firmly connected with the cross-beam T, either bolted, for example, or else attached to it by means of other known mounting means, in particular support frames or the like. Electric current to both blowers may be supplied by means of lines which are led along the cross-beam T and are suspended freely in the area adjacent thereto.

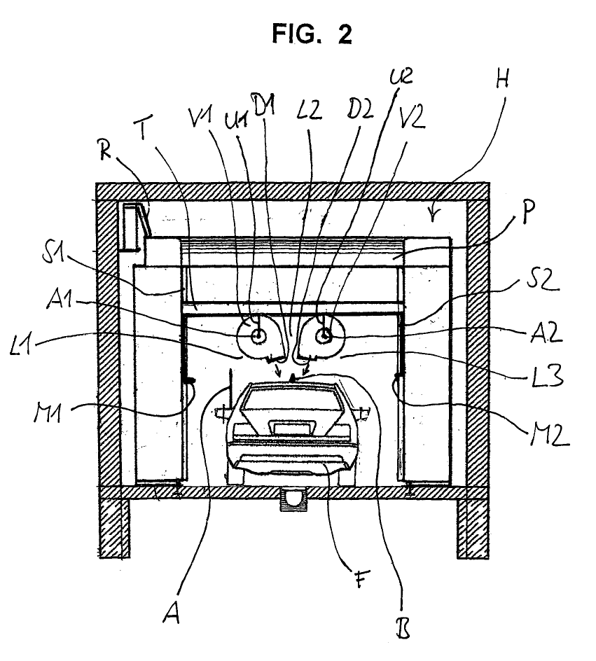

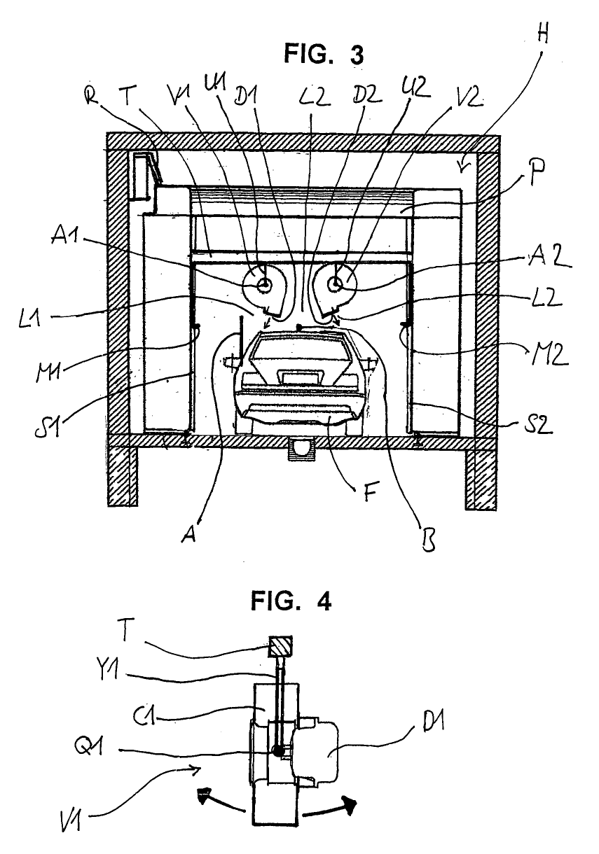

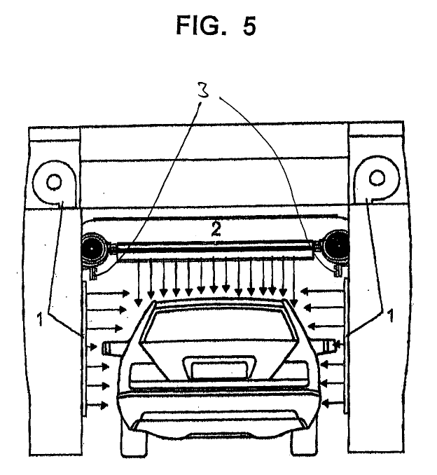

A further embodiment of this invention will be evident from FIGS. 2 and 3. This embodiment differs from the embodiment of FIG. 1 only in that each of the two blowers V1, V2 is swivel-suspended from the cross-beam T about an axis A1, A2 in the vehicle longitudinal direction. FIG. 2 shows the wash plant with the gantry moving in a forward direction. In such an arrangement, the two blowers V1, V2 are swivelled towards the inside, so that the air stream (indicated by arrows) issuing from the right-hand and the left-hand nozzle mouth arrangements D1, D2 is directed towards the middle of the vehicle. FIG. 3, on the other hand, shows the wash plant with the gantry P moving in a reverse direction. The two blowers V1, V2 are now swivelled towards the outside, so that the air stream (indicated by arrows) issuing from the right-hand and the left-hand nozzle mouth arrangements D1, D2 is directed towards the sides of the vehicle. In the embodiment illustrated, each of the two blowers V1, V2 is suspended from the cross-beam T by means of a U-shaped support frame U1, U2, with the bottom of such U-shaped support frame forming the swivel axis A1, A2. It would, however, be likewise conceivable to attach the two blowers to the cross-beam T by means of any other swivel-type or articulated mounting means known to the art. The two blowers V1, V2 may be swivelled by a driving means (not shown) suitably matching the selected type of suspension which in the case of the U-shaped support frame may be a hydraulic cylinder or the like arranged between the two blowers V1, V2, operating in both directions and actuated by the control of the gantry wash plant.

Furthermore, the blowers V1, V2 may be swivel-suspended from the cross-beam T about an axis disposed in the vehicle transverse direction. Such an embodiment of the invention is depicted in FIG. 4 showing the blower V1 with the casing removed. The blower V1 is likewise supported by a support frame Y1. In contrast to the embodiment described above the support frame is not of U-shaped design, but in form of a Y standing upside down and connected with the blower V1 on the side walls of the blower casing where provision is made for corresponding swivel pins enabling the blower V1 to be swivelled in a direction indicated by arrows about a swivel axis Q1 which is formed by the swivel pins and is disposed in the vehicle transverse direction. The support frame Y1 in turn is attached to the cross-beam T.

As is evident, the blower V1 comprises an electric motor D1 which drives a rotor blade or fan wheel C1. It would of course be equally conceivable to suspend the support frame Y1 from the cross-beam T by means of a hinge and to firmly connect its opposite ends with the blower. In this case, a turning drive attached to the cross-beam T could act directly upon the swivel pin. In case that, as is evident from FIG. 4, the swivel joint is located on the axis Q1, provision could be made for a mechanism acting upon the blower casing, which serves to carry out the swivel movement. The swivel movement can then be controlled in accordance with the control program selected at the wash plant.

As a matter of course, deviations from the embodiments shown are possible without thereby leaving the basic idea and scope of the invention.

It would thus be likewise conceivable to provide a single blower (fixed or swivel-type) which is suspended at the centre of the cross-beam instead of two blowers suspended side by side from the cross-beam, while the design of the drying gantry might otherwise show the same features as are described above. With this arrangement, however, not all the advantages of the invention, such as collision safety provided by the clear spaces, can be achieved. But due to the short distance between the blower and the nozzle mouth and due to the short length of the nozzle mouth, the blow range of the air stream obtained is so extensive that the safety distance obtainable can be much larger than with the conventional contour-following scan nozzle having a nozzle mouth which extends across the entire vehicle width. On the other hand, this arrangement affords the known advantages of an improved drying efficiency as compared to a fixed-height blower unit.

It would further be conceivable to suspend the blower or blowers from the cross-beam in such a way that they are movable in a transverse direction and then adjust the working positions of the blowers in a transverse direction in accordance with the signals obtained from scanning the vehicle.

1. A drying gantry for vehicle wash plants having:
at least one height-adjustable cross-beam to which a blower arrangement is attached for drying the surfaces of a vehicle over which the cross-beam moves, which blower arrangement is provided with a nozzle mouth arrangement forming a lower contour of the cross-beam, with the height position of the cross-beam being controllable depending on a desired distance between the lower contour of the cross-beam and the vehicle overwhich the cross-beam moves, characterised in that the lower contour of the cross-beam in a region approximately corresponding to the middle of the vehicle width and on both lateral ends of the vehicle recedes towards the top, thus forming clear spaces.

2. A drying gantry according to claim 1, wherein:
the nozzle mouth arrangement comprises a left-hand nozzle mouth and a right-hand nozzle mouth which are spaced from each other by a middle clear space in the vehicle transverse direction.

3. A drying gantry according to claim 1, wherein:
the left-hand nozzle mouth and the right-hand nozzle mouth are spaced from each other in the vehicle longitudinal direction.

4. A drying gantry according to claim 1, wherein:
the left-hand nozzle mouth and the right-hand nozzle mouth are swivel-connected with the cross-beam about an axis substantially disposed in the vehicle longitudinal direction.

5. A drying gantry according to claim 1, wherein:
the left-hand nozzle mouth and the right-hand nozzle mouth are swivel-connected with the cross-beam about an axis substantially disposed in the vehicle transverse direction.

6. A drying gantry according to claim 2, wherein:
the left-hand nozzle mouth and the right-hand nozzle mouth close the bottom ends of the blowers, respectively, which are attached to the bottom side of the cross-beam, with the blowers, due to their being spaced in the vehicle transverse direction, forming a middle clear space and receding on their outer sides towards the top, thus leaving further clear spaces in the regions corresponding to the two lateral ends of the vehicle.

7. A drying gantry according to claim 6, wherein:
the blowers are swivel-suspended from the cross-beam about an axis substantially disposed in the vehicle longitudinal direction.

8. A drying gantry according to claim 6, wherein:
the blowers are swivel-suspended from the cross-beam about an axis substantially disposed in the vehicle transverse direction.

9. A drying gantry according to claim 1, wherein:
on the cross-beam provision is made for a spray tube arrangement for prewashing the vehicle, which does not extend into any of the clear spaces.

10. A drying gantry according to claim 9, wherein:
the spray tube arrangement comprises two spray tubes arranged on the left-hand and right-hand blowers, respectively, and being disposed parallel to the respective nozzle mouths.

11. A drying gantry according to claim 2, wherein:
the left-hand nozzle mouth and the right-hand nozzle mouth are spaced from each other in the vehicle longitudinal direction.

12. A drying gantry according to claim 2, wherein:
the left-hand nozzle mouth and the right-hand nozzle mouth are swivel-connected with the cross-beam about an axis substantially disposed in the vehicle longitudinal direction.

13. A drying gantry according to claim 3, wherein:
the left-hand nozzle mouth and the right-hand nozzle mouth are swivel-connected with the cross-beam about an axis substantially disposed in the vehicle longitudinal direction.

14. A drying gantry according to claim 2, wherein: the left-hand nozzle mouth and the right-hand nozzle mouth are swivel-connected with the cross-beam about an axis substantially disposed in the vehicle transverse direction.

15. A drying gantry according to claim 3, wherein:
the left-hand nozzle mouth and the right-hand nozzle mouth are swivel-connected with the cross-beam about an axis substantially disposed in the vehicle transverse direction.
